(19) United States
(12) Patent Application Publication
(10) Pub. No.: US 2018/0279386 A1
(43) Pub. Date: Sep. 27, 2018

(54) METHOD AND APPARATUS FOR LISTENING BEFORE TALK

(71) Applicant: Alcatel Lucent, Nozay (FR)

(72) Inventors: Jianguo Liu, Shanghai (CN); Tao Tao, Shanghai (CN); Yan Meng, Shanghai (CN); Feng Han, Shanghai (CN); Junrong Gu, Shanghai (CN); Gang Shen, Shanghai (CN)

(73) Assignee: Alcatel Lucent, Nozay (FR)

(21) Appl. No.: 15/762,329

(22) PCT Filed: Aug. 25, 2016
(86) PCT No.: PCT/IB2016/001330

§ 371 Date: Mar. 22, 2018

(30) Foreign Application Priority Data
Sep. 25, 2015 (CN) 201510623304.8

(51) Int. Cl. H04W 74/08; H04W 16/14

(52) U.S. Cl. CPC H04W 74/0875; H04W 74/0808; H04W 16/14

(57) ABSTRACT

Embodiments of the present disclosure relate to a method and apparatus for listening before talk (LBT). A method of LBT is provided. The method comprises: determining an access priority class based on a plurality of types of traffic to be transmitted on a plurality of carriers; determining a LBT parameter based on the determined access priority class; and performing the LBT using the LBT parameter.

### TECHNICAL FIELD

Embodiments of the present disclosure generally relate to communications technologies, and more specifically relate to a method and apparatus for talk before listening (LBT).

### BACKGROUND

With constant increase of traffic carried by a cellular network, individual cellular network operators need more spectrums to meet demands for increasing traffic. In this case, unlicensed spectrums become beneficial supplements to licensed spectrums specific to respective operators. Because the unlicensed spectrums may be shared, it is possible that a certain unlicensed carrier is contended. This contention may be solved using a Listening before Talk (LBT) technology. Specifically, before performing traffic transmission on a certain carrier, a clear channel assessment (CCA) may be first performed on the carrier so as to detect whether there is a channel in an idle state. Only if an idle channel is detected, the carrier may be used for the traffic transmission.

A licensed assisted access (LAA) using a LTE (LAA-LTE) technology is a typical technology enabling the supplements of licensed spectrums with unlicensed spectrums. In a typical LAA-LTE-enabled network, the eNB may provide one master cell and a plurality of secondary cells, where the master cell may operate on the licensed carriers, while the secondary cells may operate on unlicensed carriers. Because interference conditions on individual carriers are different, the eNB may separately perform LBT on each unlicensed carrier. In response to the success of the LBT on a certain carrier, the eNB may activate transmission on the carrier. When a plurality of secondary cells occupy a plurality of neighboring unlicensed carriers, due to radio frequency (RF) leakage existing between neighboring carriers, when traffic transmission is being performed on a carrier, the probability of the success of the LBT on the neighboring carriers will be greatly reduced.

In order to address the above problem of reduction of the probability of the LBT success due to RF leakage, in relevant standards in the third-generation partnership project (3GPP), it has been proposed to temporally align the LBT and transmissions on respective unlicensed carriers. For example, if the LBT is performed on a carriers, before a LBT operation is completed on the carrier, fast CCA operations are performed on other carriers. In the context of the present disclosure, the fast CCA refers to a channel assessment with a contention window having a fixed and relatively short (for example, 25 milliseconds) size. After the LBT operation is completed on the carrier, traffic transmissions are simultaneously performed on carriers that have idle channels. As another example, a LBT synchronous board (LSB) may be set, and the LBT is simultaneously performed on a plurality of carriers. In response to determining that LBT will be first completed on a certain carrier before expiration of the LSB, LBT operations on other carriers will be stopped, and before the performing of the LBT that will be first completed, the fast CCAs are performed on other carriers. Then, in response to the expiration of the LSB, the transmissions are simultaneously performed on the carriers on which idle channels are detected. However, the 3GPP only provides a basic conception for this time alignment method, without providing a specific implementation procedure.

### SUMMARY

Generally, embodiments of the present disclosure provide a method and apparatus for listening before talk (LBT).

In the first aspect, the embodiments of the present disclosure provide a method of LBT. The method comprises: determining an access priority class based on a plurality of types of traffic to be transmitted on a plurality of carriers; determining a LBT parameter based on the determined access priority class; and performing the LBT using the LBT parameter.

In the second aspect, the embodiments of the present disclosure provide an apparatus for LBT. The apparatus comprises: a priority determining unit configured to determine an access priority class based on a plurality of types of traffic to be transmitted on a plurality of carriers; a parameter determining unit configured to determine a LBT parameter based on the determined access priority class; and a listening unit configured to perform the LBT using the LBT parameter.

In the third aspect, the embodiments of the present disclosure provide an apparatus for LBT. The apparatus comprises: a processor and a memory storing computer program instructions, the memory and the computer program instructions configured to, with the processor, cause the apparatus to perform the method according to the first aspect of the present disclosure.

Through the following description, it will be understood that according to embodiments of the present disclosure, the access priority classes may be determined based on a plurality of types of traffic to be transmitted on a plurality of unlicensed carriers in uplink and downlink. Accordingly, the LBT parameter is determined, and the LBT is performed. In this way, the LBT may be effectively performed in a network enabling a plurality of unlicensed carriers. Particularly in the case that a plurality of unlicensed carriers are adjacent, reduction of a success ratio of the LBT caused by RF leakage between neighboring carriers may be effectively avoided. Other features and advantages of the present disclosure will become easily understood through the description below.

### BRIEF DESCRIPTION OF THE DRAWINGS

FIG. 1 illustrates a communication network in which embodiments of the present disclosure may be implemented;

FIG. 2 illustrates a flow diagram of a method of LBT according to one embodiment of the present disclosure;

FIG. 3 illustrates a flow diagram of a method of LBT according to another embodiment of the present disclosure;

FIG. 4 illustrates a flow diagram of a method of LBT according to a further embodiment of the present disclosure;

FIG. 5 illustrates a flow diagram of a method of LBT according to yet another embodiment of the present disclosure; and

FIG. 6 illustrates a block diagram of an apparatus for LBT according to one embodiment of the present disclosure.

### DETAILED DESCRIPTION

Now, the principles of the present disclosure will be described with reference to a plurality of exemplary embodiments. It should be understood that these embodiments are only for enabling those skilled in the art to better understand and further implement the present disclosure, without limiting the scope of the present disclosure in any manner.

As used herein, the term “base station” may refer to node B (NodeB or NB), an evolved node B (eNodeB or eNB), or a low-power node such as a pico node, a femto node, and the like.

As used herein, the term “terminal device” may refer to any terminal device capable of communicating with the base station. As an example, the terminal device may comprise a mobile terminal (MT), a subscriber station (SS), a portable subscriber station (PSS), a mobile station (MS), or an access terminal (AT).

As used herein, the term “include” and its variants are open inclusion which means “including, but not limited to.” The term “based on” means “at least partially based on.” The term “one embodiment” represents “at least one embodiment”; the term “another embodiment” represents “at least one further embodiment.” Relevant definitions of other terms will be provided in the following description.

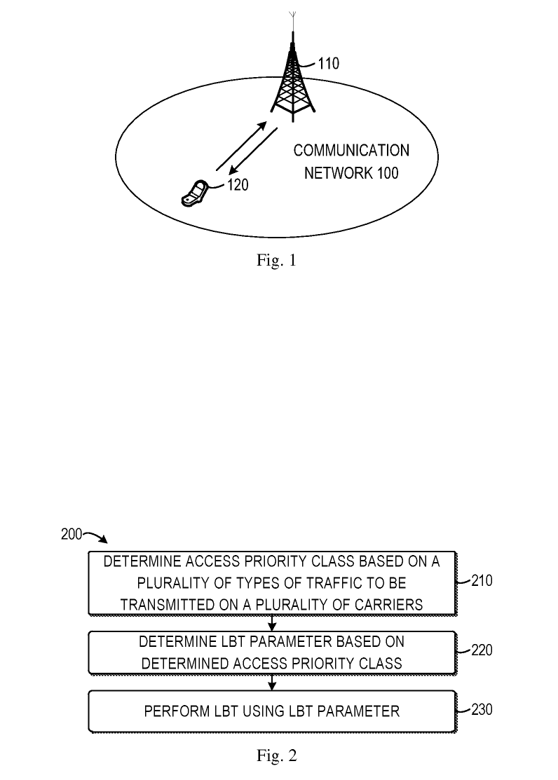

FIG. 1 illustrates a communication network 100 in which embodiments of the present disclosure may be implemented therein. The communication network 100 as shown in FIG. 1 may comprise a base station 110 and a terminal device 120. It should be understood that the number of base stations and the number of terminal devices as illustrated in FIG. 1 are only for the purpose of illustration, without suggesting any limitation. In the communication network 100, there may be any suitable number of base stations or terminal devices. In addition, the communication network 100 may operate on a plurality of carriers (for example, carriers A, B and C), where these carriers may be adjacent or not adjacent, and these carriers may be licensed carriers, unlicensed carriers, or a combination thereof.

Communications between the base station 110 and the terminal device 120 may be implemented according to any suitable communication protocol, including, but not limited to, first generation (1G), second generation (2.5G), third generation (3G), fourth generation (4G) communication protocol, fifth generation (5G) communication protocol, and/or any other protocol currently known or future developed.

The base station 110 and the terminal device 120 may use any suitable wireless communication technologies, including, but not limited to, a code division multiple access (CDMA), a frequency division multiple access (FDMA), a time division multiple access (TDMA), a frequency division duplexing (FDD), a time division duplexing (TDD), a multiple input multiple output (MIMO), an orthogonal frequency division multiple access (OFDM), and any other known or future developed technologies.

In the communication network 100, the base station 110 and the terminal device 120 may use a plurality of carriers A, B and C to communicate. As described above, when the carriers A, B and C are adjacent, due to RF leakage, the communication on the carrier A will cause failures of LBT on the adjacent carriers B and C.

To this end, it may be considered to temporarily align the LBT and the transmissions on respective carriers. For example, the base station 110 may perform the LBT on the carrier A. Before completion of the LBT on the carrier A, fast CCAs are performed on the carriers B and C. After the completion of the LBT on the carrier A, communicates with the terminal device 120 are simultaneously performed on the carriers having idle channels. As another example, a LSB may be set, and the base station 110 simultaneously performs the LBT on the carriers A, B and C. In response to determining that the LBT on the carrier A will be first completed before expiration of the LSB, the LBT on the carriers B and C is stopped. Before the LBT on the carrier A is completed, the fast CCAs are performed on the carriers B and C. Then, in response to the expiration of the LSB, communications with the terminal device 120 are simultaneously performed on the carriers on which idle channels are detected.

The base station needs to configure LBT parameters in advance when performing the LBT operations on the carrier A, B or C. Examples of the LBT parameters include, but not limited to, a contention window size (CWS), a maximum contention window (CWMax), a minimum contention window (CWMin), a random backoff counter, a backoff delay time and a transmission opportunity (TXOP), and the like. Settings of these parameters have a significant impact on the success of the LBT and the success of the channel access. Therefore, when the LBT operations need to be performed on a plurality of carriers, it becomes an imminent problem how the LBT parameters are set.

In a wireless fidelity (Wi-Fi) network operating on a plurality of carriers as well, a LBT parameter may be set based on quality of service (QoS) of the traffic carried on the carriers. Because a plurality of carriers are used to simultaneously transmit the same traffic in the Wi-Fi network, a common LBT parameter is used for the plurality of carriers. However, in the LAA-LTE network, a plurality of carriers may carry different traffic, and individual carriers may be used for carrying different traffic for different terminal devices. Therefore, an eligible method is needed to set the LBT parameters for multiple carriers so as to meet access needs for different traffic.

FIG. 2 illustrated a flow diagram of a method 200 of the LBT according to one embodiment of the present disclosure. It should be understood that the method 200 may be implemented by a base station 110 or a terminal device 120 as illustrated in FIG. 1. For the purpose of illustration, the method 200 will be described below from the perspective of the base station 110.

The method 200 starts from step 210, where the base station 110 determines an access priority class based on a plurality of types of traffic to be transmitted on a plurality of carriers A, B and C. In the context of the present disclosure, the term “access priority class” refers to a priority of accessing a channel on a certain carrier. The higher the priority is, the faster the channel is accessed. According to embodiments of the present disclosure, the access priority class may be determined according to any suitable rules. In one embodiment, one access priority class may be determined for each carrier based on the type of the traffic to be transmitted on the carrier.

For example, the base station 110 may maintain at least one set of LBT priority classes for a plurality of carriers, where each of the LBT priority class corresponds to at least one type of traffic. Then, the base station 110 may select a LBT priority class as the access priority class from the set of LBT priority classes based on the type of the traffic on an individual carrier. According to embodiments of the present disclosure, a set of LBT priority classes may be maintained for each carrier, and a set of LBT priority classes may also be maintained for a plurality of carriers. As an example, if an access priority class is determined for each carrier, a set of LBT priority classes may be maintained for each carrier. Accordingly, a LBT priority class used may be selected as the access priority class from a set of LBT priority classes for each carrier.

According to embodiments of the present disclosure, the LBT priority class may correspond to a certain type of traffic based on any suitable traffic characteristics. As an example, a certain type of traffic may correspond to a certain LBT priority class based on QoS requirements. For example, voice traffic that has a high QoS requirement may correspond to a high LBT priority class.

If a plurality of types of traffic is to be transmitted on a carrier, a LBT priority class corresponding to one of the types of traffic may be selected as the access priority class. According to embodiments of the present disclosure, this selection may be performed using any suitable rule. As an example, a lowest one of the LBT priority classes corresponding to the plurality of types of the traffic may be selected as the access priority class. As an alternative, in order to meet the access needs for high priority traffic, the highest one of the LBT priority classes corresponding to the plurality of types of the traffic may be selected as the access priority class.

In addition to the determination of the access priority class for each carrier, in another embodiment, one access priority class may also be determined for a plurality of carriers. In this embodiment, the base station 110 may likewise maintain at least one set of LBT priority classes for a plurality of carriers. For example, a set of LBT priority classes may be maintained for a plurality of carriers, and then one LBT priority class may be selected as the access priority class from the set of service types based on a plurality of types of traffic on the plurality of carriers. Similar to determining an access priority class for each carrier, a lowest or highest one of the LBT priority classes corresponding to the plurality of types of traffic may be selected as the access priority class.

It should be understood that the method described above where the base station 110 maintains a set of LBT priority classes and selects, a LBT priority class as the access priority class from the maintained LBT priority classes is only an example. Any method of determining the access priority class based on the type of traffic may be employed, and the scope of the present disclosure will not be limited in this regard.

Next, the method 200 proceeds to step 220 where the base station 110 determines a LBT parameter based on the determined access priority class. In one embodiment, one access priority class may be associated with one set of LBT parameters. Correspondingly, the LBT parameters associated with the determined access priority class may be determined as the LBT parameters for the LBT. For example, one LBT priority class may correspond to one set of LBT parameters. After the LBT priority class is selected as the access priority class, the access priority class is associated with the LBT parameters corresponding to the selected LBT priority class. The LBT parameters include, for example, a CWS, a CWMax, a CWMin, a random backoff counter, a backoff delay time, a TXOP, and the like. It should be understood that the method of determining the LBT parameter for the LBT based on the correspondence between the LBT priority class and the LBT parameter is only for the purpose of illustration, without suggesting any limitations. Any suitable method may be used to determine LBT parameters based on the access priority class. The scope of the present disclosure will not be limited in this aspect.

Then, the method 200 proceeds to step 230 where the base station 110 performs the LBT using the determined LBT parameter. In this way, the LBT may be effectively performed in a network that enables a plurality of carriers. Particularly, in the case that the plurality of carriers are adjacent, the embodiments of the present disclosure may effectively avoid drop of the LBT success rate caused by the RF leakage between the neighboring carriers.

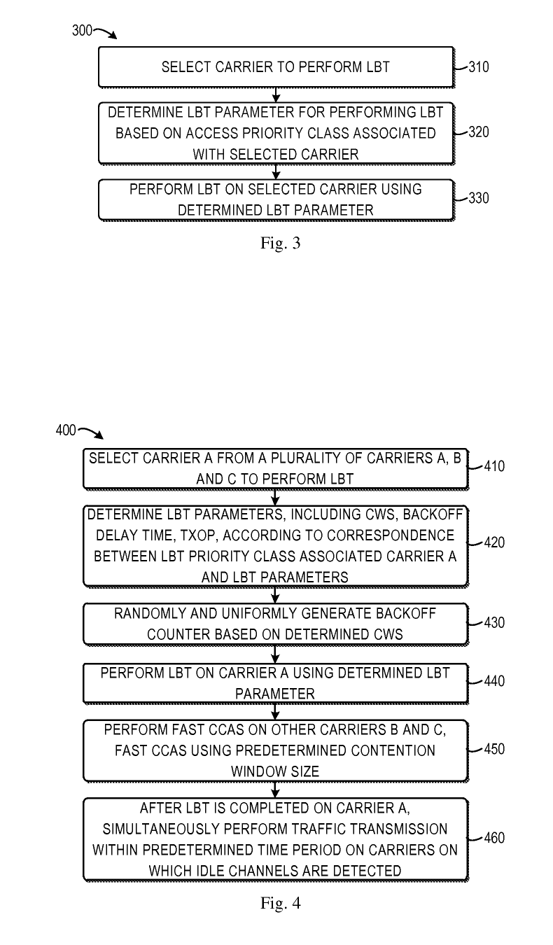

A specific example will be described below with reference to FIG. 3, which illustrates a flow diagram of a method 300 of the LBT according to another embodiment of the present disclosure.

The method 300 as shown in FIG. 3 starts from step 310 where the base station 110 selects a carrier for performing the LBT. According to embodiments of the present disclosure, any suitable carrier may be selected to perform the LBT. In one embodiment, the base statin 110 may select a carrier from the plurality of carriers to perform the LBT. In this example, the base station 110 may perform the carrier selection using any suitable criterion. For example, a carrier with low loads may be selected. Alternatively, considering fairness, a carrier may be selected randomly from the plurality of carriers. In addition, the carrier selection may be performed in any suitable timing. For example, the carrier selection may be performed periodically or based on event-trigger. In addition to selecting one carrier to perform LBT, in another embodiment, the base station 110 may also perform the LBT on all carriers.

Next, the method 300 proceeds to step 320 where the base station 110 determines a LBT parameter for performing the LBT based on the access priority class associated with the selected carrier. As described above, the LBT parameter, which corresponds to the LBT priority class acting as the access priority class, may be used as the LBT parameter for the carrier. Then, in step 330, the base station 110 performs the LBT on the selected carrier using the determined LBT parameter.

According to embodiments of the present disclosure, the step of selecting a carrier and the step of determining a priority may be performed in any order. For example, the carrier may be selected first, and then the access priority class of the selected carrier is determined. As an alternative, the access priority class may be determined for all carriers first, and then one of the carriers is selected to perform the LBT. The method of determining the priority is similar to that described with reference to FIG. 2, and therefore the details will not be repeated. A procedure implemented by the base station 110 when selecting a carrier for performing the LBT will be described below with reference to FIG. 4.

The method 400 as shown in FIG. 4 starts from step 410 where the base station 110 selects a carrier A from a plurality of carriers A, B and C to perform the LBT. In step 420, the base station 110 determines LBT parameters, including, for example, a CWS, a backoff delay time, a TXOP, and the like, according to the correspondence relationship between the LBT priority class associated with the carrier A and the LBT parameters. In step 430, the base station 110 randomly and uniformly generates a backoff counter based on the determined CWS. The value of the backoff counter is ranged from 0 to CWS.

Next, in step 440, the base station 110 performs the LBT on the carrier A using the determined LBT parameter. For example, the base station 110 may perform an initial CCA operation according to the determined CWS. If the initial CCA fails, the base station 110 re-performs an extended CCA based on the generated backoff counter, till the backoff counter returns to zero. Before the LBT is completed on the carrier A, in step 450, the base station 110 performs fast CCAs on other carriers B and C, and the fast CCAs use a predetermined contention window size of, for example, 25 milliseconds.

Then, in step 460, after the LBT is completed on the carrier A, the base station 110 simultaneously performs traffic transmission within a predetermined time period on the carriers on which idle channels are detected. For example, the predetermined time period may correspond to the determined TXOP. According to embodiments of the present disclosure, the TXOP may be set in association with the LBT priority class in any manner. In one embodiment, in the case that in response to a plurality of types of traffic existing, the highest one of the LBT priority classes corresponding to the plurality of types of traffics is selected as the access priority class, in order to ensure the fairness of the channel accesses between different networks and, for example, a WiFi network, the TXOP may be set to be an available minimum value. In another embodiment, the TXOP may be set as a fixed value independent of the LBT priority class.

Optionally, in the method 400, the base station 110 may also adaptively adjust the CWS based on a channel detection result and a feedback from the terminal device 120. For example, the base station 110 may determine the CWMin and the CWMax based on the access priority class determined for the carrier A. When the LBT is performed on the carrier A at the first time, the CWMin is used as the CWS. When the LBT is performed next time in response to a channel assessment failure or NACK fed back from the terminal device, the CWS is multiplied till reaching the CWMax.

Optionally, when the carrier selection is re-performed, and another carrier (for example, the carrier B) is selected to perform the LBT, the LBT parameters may be reset according to the access priority class associated with the carrier B. For example, the LBT parameters are reset as the LBT parameters corresponding to the access priority class associated with the carrier B.

Next, still with reference to FIG. 3, as described above, in step 310 of the method 300, in addition to selecting one carrier to perform the LBT, the base station 110 may also perform the LBT on all of the carriers. Accordingly, in step 320, the base station 110 may determine, for each carrier, the LBT parameter for performing the LBT, based on the determined access priority class associated with the carrier. Then, in step 330, the base station 110 performs, on each carrier, the LBT using the LBT parameter determined for the carrier. As described above, according to embodiments of the present disclosure, each carrier may be associated with one access priority class, or all carriers are associated with the same access priority class.

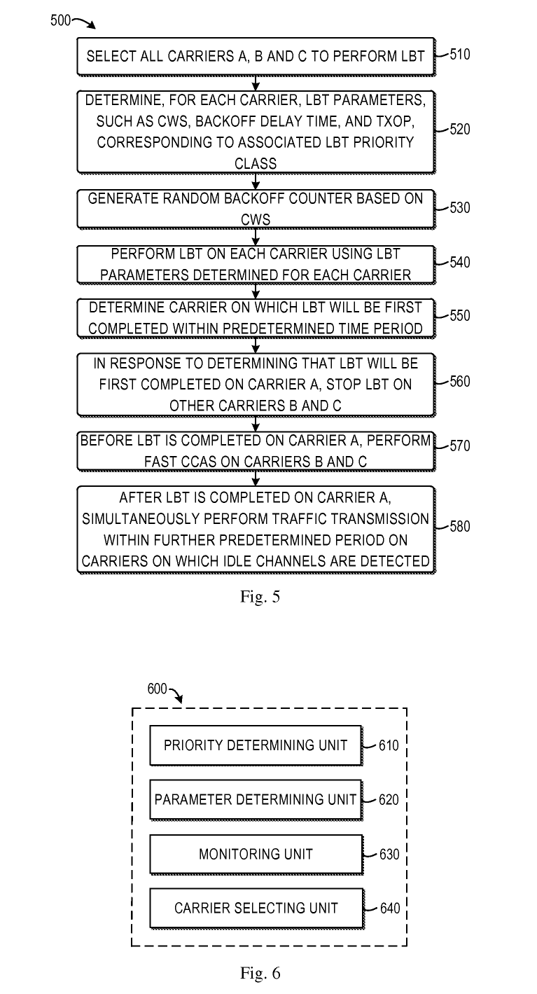

A specific example will be described below with reference to FIG. 5. As shown in FIG. 5, a method 500 starts from step 510 where the base station 110 selects all carriers A, B and C to perform the LBT. Next, in step 520, the base station determines, for each carrier, LBT parameters, including a CWS, a backoff delay time, a TXOP, and the like, which correspond to the LBT priority class acting as the associated access priority class. In step 530, the base station generates a random backoff counter based on the CWS. In step 540, the base station 110 uses the LBT parameters determined for each of the carriers to perform the LBT on each of the carriers.

Next, in step 550, the base station 110 determines a carrier on which the LBT will be first completed within a predetermined time period. An example of the predetermined time period includes, but not limited to, a LSB. Next, in step 560, in response to determining that the LBT will be first completed on the carrier A, the LBT on other carriers B and C is stopped. In step 570, before the LBT is completed on the carrier A, the base station 110 performs fast CCAs with a predetermined contention window size on the carriers B and C. In step 580, after the LBT is completed on the carrier A, the base station 110 simultaneously performs traffic transmission within a further predetermined period on the carriers on which idle channels are detected.

In the method 500, the procedures of performing the LBT and the settings of predetermined time period for the traffic transmission are similar to those in the method 400 as described with reference to FIG. 4, which will not be detailed here.

Similar to the method 400, in the method 500, the base station 110 may also adaptively adjust the CWS based on the channel detection result and the feedback from the terminal device 120. In one embodiment, the base station 110 may perform the adjustment only for the carrier on which the LBT is first completed. In another embodiment, the base station 110 may perform the adjustment for all of the carriers. The approach of adjusting the CWS is similar to that in the method 400 described with reference to FIG. 4, and therefore the details will not be repeated here.

FIG. 6 illustrates a block diagram of an apparatus 600 for LBT according to one embodiment of the present disclosure. It should be understood that the apparatus 600 may be implemented as a base station 110 or a terminal device 120 as illustrated in FIG. 1.

As shown, the apparatus 600 includes a priority determining unit 610, a parameter determining unit 620, and a listening unit 630. The priority determining unit 610 is configured to determine an access priority class based on a plurality of types of traffic to be transmitted on the plurality of carriers. The parameter determining unit 620 is configured to determine a LBT parameter based on the determined access priority class. Moreover, the listening unit 630 is configured to perform the LBT using the determined LBT parameter.

In one embodiment, the apparatus 600 may further comprise a carrier selecting unit 640. The carrier selecting unit 640 is configured to select at least one carrier from a plurality of carriers to perform the LBT. In this embodiment, the parameter determining unit 620 may be further configured to determine the LBT parameter based on the access priority class associated with the selected carrier. Furthermore, the listening unit 630 may be further configured to perform the LBT on the selected carrier using the determined LBT.

In one embodiment, the carrier selecting unit 640 may be further configured to select a carrier from a plurality of carriers to perform the LBT. In this embodiment, the apparatus 600 may further comprise: a first channel assessment unit configured to perform fast clear channel assessments on others of the plurality of carriers before the LBT is completed on the selected carrier, the fast clear channel assessments using a predetermined contention window size; and a first transmission unit configured to simultaneously transmit traffic within the first predetermined time period on the carriers on which idle channels are detected after the LBT is completed on the selected carrier.

In one embodiment, the carrier selecting unit 640 may be further configured to select all of the plurality of carriers to perform the LBT. In this embodiment, the apparatus 600 may further comprise: a carrier determining unit configured to determine a first carrier of the plurality of carriers on which the LBT will be completed first within a second predetermined time period; a listening stopping unit configured to stop the LBT on other carriers of the plurality of carriers; a second channel assessment unit configured to perform fast clear channel assessments on the other carriers of the plurality of carriers before the LBT is completed on the first carrier, the fast clear channel assessments using a predetermined contention window size; and a second transmission unit configured to simultaneously transmit traffic within a third predetermined time period on the carriers on which idle channels are detected after the LBT is completed on the first carrier.

In one embodiment, the LBT parameter comprises a contention window size. In this example, the apparatus 600 may further comprise: a first parameter adjusting unit configured to adaptively adjust the determined contention window size for the at least one selected carrier. As an alternative example, the apparatus 600 may further comprise: a second parameter adjusting unit configured to adaptively adjust the determined contention window size for all of the plurality of carriers.

In one embodiment, the priority determining unit 610 may comprise: a priority maintaining unit configured to maintain at least one set of LBT priority classes for the plurality of carriers, wherein one LBT priority class corresponds to at least one type of traffic; and a priority selecting unit configured to select at least one LBT priority class as the access priority class from the at least one set of LBT priority classes based on the types of traffic to be transmitted on the plurality of carriers.

In one embodiment, the priority maintaining unit may be further configured to maintain a set of LBT priority classes for each of the plurality of carriers. Moreover, the priority selecting unit may be further configured to select, for each of the carriers, one LBT priority class as the access priority class from the set of LBT priority classes based on the types of the traffic to be transmitted on the carrier. In one embodiment, if a plurality of types of traffic is to be transmitted on one carrier of the plurality of carriers, the priority selection unit may be further configured to select the highest one of the LBT priority classes corresponding to the plurality of types from the set of LBT priority classes as the access priority class.

In one embodiment, the priority maintaining unit may be further configured to maintain a set of LBT priority classes for the plurality of carriers. Furthermore, the priority selecting unit may be further configured to select a LBT priority class as the access priority class from the set of LBT priority classes based on the plurality of types of the traffic to be transmitted on the plurality of carriers. In one embodiment, the priority selecting unit may be further configured to select, from this set of LBT priority classes, the highest one of the LBT priority classes corresponding to the plurality of types as the access priority class.

In one embodiment, the LBT parameter includes a transmission opportunity. In this embodiment, the parameter determining unit 620 may further comprise: a transmission opportunity setting unit configured to set the transmission opportunity to be an available minimum value in response to the highest LBT priority class acting as the access priority class.

It should be understood that the units included in the apparatus 600 correspond to the respective steps in methods 200, 300, 400, and 500 described with reference to FIGS. 2-5. Therefore, the operations and features as described above with reference to FIGS. 2-5 are likewise applicable to the device 600 and the units included therein and achieve the same effects. Details will not be provided here.

The units included in the apparatus 600 may be implemented using various manners, including software, hardware, firmware or any combination thereof. In one embodiment, one or more units may be implemented using software and/or firmware, for example, a machine executable instruction stored on the storage medium. In addition to or instead of the machine executable instructions, part or all of the units in the apparatus 600 may be at least partially implemented by one or more hardware logic units. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), and the like.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

By way of example, embodiments of the present disclosure can be described in the general context of machine-executable instructions, such as those included in program modules, being executed in a device on a target real or virtual processor. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of this disclosure, a machine readable medium may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or functional actions, it is to be understood that the present disclosure defined in the appended claims is not necessarily limited to the specific features or actions described above. Rather, the specific features and acts described above are disclosed as example forms of implementing the claims.

1. A method of listening before talk (LBT), comprising:
determining an access priority class based on a plurality of types of traffic to be transmitted on a plurality of carriers;
determining a LBT parameter based on the determined access priority class; and
performing the LBT using the LBT parameter.

2. The method according to claim 1, further comprising:
selecting at least one carrier from the plurality of carriers to perform the LBT,
wherein determining the LBT parameter based on the determined access priority class comprises: determining the LBT parameter based on the access priority class associated with the selected carrier, and
wherein performing the LBT using the LBT parameter comprises: performing the LBT on the selected carrier using the determined LBT parameter.

3. The method according to claim 2, wherein selecting the at least one carrier from the plurality of carriers to perform the LBT comprises: selecting one carrier from the plurality of carriers to perform the LBT, and the method further comprises:
before the LBT is completed on the selected carrier, performing fast clear channel assessments on other carriers of the plurality of carriers, wherein the fast clear channel assessments use a predetermined contention window size; and
after the LBT is completed on the selected carrier, simultaneously transmitting the traffic within a first predetermined time period on the carriers on which idle channels are detected.

4. The method according to claim 2, wherein selecting the at least one carrier from the plurality of carriers to perform the LBT comprises: selecting all of the plurality of carriers to perform the LBT, and the method further comprises:
determining, from the plurality of carriers, a first carrier on which the LBT will first be completed within a second predetermined time period;
in response to the determination of the first carrier, stopping the LBT on other carriers of the plurality of carriers;
before the LBT is completed on the first carrier, performing fast clear channel assessments on the other carriers of the plurality of carriers, wherein the fast clear channel assessments use a predetermined contention window size; and
after the LBT is completed on the first carrier, simultaneously transmitting the traffic within a third predetermined time period on the carriers on which idle channels are detected.

5. The method according to claim 2, wherein determining the LBT parameter comprises: determining a contention window size, and the method further comprises:
adaptively adjusting the determined contention window size for the at least one selected carrier.

6. The method according to claim 2, wherein determining the LBT parameter comprises: determining a contention window size, and the method further comprises:
adaptively adjusting the determined contention window size for all of the plurality of carriers.

7. The method according to claim 1, wherein determining the access priority class comprises:
maintaining at least one set of LBT priority classes for the plurality of carriers, wherein one LBT priority class in the at least one set of LBT priority classes corresponds to at least one type of traffic; and
selecting at least one LBT priority class as the access priority class from the at least one set of LBT priority classes based on the types of the traffic to be transmitted on the plurality of carriers.

8. The method according to claim 7,
wherein maintaining the at least one set of LBT priority classes for the plurality of carriers comprises:
maintaining a set of LBT priority classes for each of the plurality of carriers, and
wherein selecting the at least one LBT priority class as the access priority class from the at least one set of LBT priority classes comprises:
for each of the carriers, selecting a LBT priority class as the access priority class from the set of LBT priority classes based on the type of the traffic to be transmitted on the carrier.

9. The method according to claim 8, wherein selecting the at least one LBT priority class as the access priority class from the at least one set of LBT priority classes comprises:
if a plurality of types of traffic is to be transmitted on one of the plurality of carriers, for the one of the plurality of carriers, selecting, from the set of LBT priority classes, a highest or lowest one of the LBT priority classes corresponding to the plurality of types as the access priority class.

10. The method according to claim 7,
wherein maintaining the at least one set of LBT priority classes for the plurality of carriers comprises:
maintaining a set of LBT priority classes for the plurality of carriers, and
wherein selecting the at least one LBT priority class as the access priority class from the at least one set of LBT priority classes comprises:
selecting one LBT priority class as the access priority class from the set of LBT priority classes based on the plurality of types of the traffic to the transmitted on the plurality of carriers.

11. The method according to claim 10, wherein selecting the one LBT priority class as the access priority from the set of LBT priority classes based on the plurality of types of the traffic to be transmitted on the plurality of carriers comprises:
selecting, from the set of LBT priority classes, a highest or lowest one of the LBT priority classes corresponding to the plurality of types as the access priority level.

12. The method according to claim 9 or 11, wherein the LBT parameter include a transmission opportunity, and determining the LBT based on the determined access priority class comprises:
in response to the highest LBT priority class acting as the access priority class, setting the transmission opportunity to be an available minimum value.

13. An apparatus for listening before talk (LBT), comprising:
a priority determining unit configured to determine an access priority class based on a plurality of types of traffic to be transmitted on a plurality of carriers;
a parameter determining unit configured to determine a LBT parameter based on the determined access priority class; and
a listening unit configured to perform the LBT using the LBT parameter.

14. The apparatus according to claim 13, further comprising:
a carrier selecting unit configured to select at least one carrier from the plurality of carriers to perform the LBT,
wherein the parameter determining unit is further configured to determine the LBT parameter based on the access priority class associated with the selected carrier, and
wherein the listening unit is further configured to perform the LBT on the selected carrier using the determined LBT parameter.

15.-24. (canceled)

25. A device for listening before talk (LBT), comprising:
a processor, and
a memory storing computer program instructions, the memory and the computer program instructions are configured to, with the processor, cause the device to perform the method according to claim 1.
